(19) United States
(12) Patent Application Publication
(10) Pub. No.: US 2010/0176253 A1
(43) Pub. Date: Jul. 15, 2010

(54) APPARATUS FOR CONNECTING SUCKING PLATE AND TABLEWARES FOR TABLE PROVIDED WITH THE SAME

(76) Inventor: Young Suck Son, Gyeonggi-do (KR)

Correspondence Address: CHRISTOPHER PAUL MITCHELL, 888 16TH ST., NW, SUITE 800, WASHINGTON, DC, 20006, US

(21) Appl. No.: 12/520,533

(22) PCT Filed: Dec. 18, 2007
(86) PCT No.: PCT/KR07/06656

§ 371 Date: Mar. 22, 2010

(30) Foreign Application Priority Data
Dec. 19, 2006 (KR) 10-2006-0129963
Jul. 2, 2007 (KR) 10-2007-0066180
Oct. 7, 2007 (KR) 10-2007-0098845

(51) Int. Cl. A47G 29/087; F16M 11/04; F16B 47/00

(52) U.S. Cl. 248/121; 248/206.1

(57) ABSTRACT

Disclosed herein is an apparatus for fastening tableware. The apparatus includes a piece of tableware, a suction unit, a support column, and a locking unit. The tableware is provided with a space in which food is contained. The suction unit is closely attached to a desk or table using vacuum pressure. The support column is configured to protrude upwards from the suction unit. The locking unit is used to couple the tableware to the support column. When the support column and the tableware are coupled with each other, the difference in vertical position between the tableware and the support column is adjusted so that the tableware is not inclined.

### TECHNICAL FIELD

The present invention relates to tableware that is used for meals, and, more particularly, to an apparatus for fastening tableware, in which a suction unit for attaching to a table using a vacuum formed by a suction is provided on one side of a piece of tableware, and a locking part and a counter locking part are provided in order to integratedly lock the suction unit with the tableware, so that the tableware is prevented from being displaced by attaching the tableware to the table using the suction force of the suction unit, with the result that the frequently occurring event in which children or toddlers spill food by knocking their tableware over during the meal can be prevented.

### BACKGROUND ART

Generally, the term ‘tableware’ refers inclusively to all types of containers, such as cups, rice bowls, and soup bowls, which are utensils for home use.

However, when such tableware is used, the event in which children and toddlers knock their tableware over or spill food contained in the tableware while having a meal occurs frequently because they have not used the tableware for a sufficient period of time and are inexpert in handling the tableware, spoons, and chopsticks. Accordingly, the attitude of an onlooker has been assumed because such conduct is essentially caused by undeveloped motor nerves and by a mismatch in size between tableware or tables and the children. That is, in order to actively solve this problem, no invention has been proposed.

Furthermore, an advantage is provided to adults who wish to eat food in the state in which tableware is attached to a table so that it is not shaken. That is, in the case where adults must necessarily have a meal in places that are slightly inclined, or in the case where adults must have a meal in trains or vehicles, there is a possibility in which the tableware is moved by a shock, and it is very inconvenient to have a meal while holding the tableware. However, sufficient effort has not yet been made to actively solve the above-described problem.

### DISCLOSURE OF INVENTION

### Technical Problem

Accordingly, the present invention has been made keeping in mind the above problems occurring in the prior art, and an object of the present invention is to provide an apparatus for fastening tableware, in which a suction unit for attaching to a table using a vacuum formed by a suction is provided on one side of a piece of tableware, and a locking part and a counter locking part are provided in order to integratedly lock the suction unit with the tableware, so that the tableware is prevented from being displaced by attaching the tableware to the table using the suction force of the suction unit, with the result that the frequently occurring event in which children or toddlers spill food by knocking their tableware over during the meal can be prevented.

Another object of the present invention is to provide a suction unit, in which a stopper is configured to be elastically actuated and to be laterally raised when it is pressed by a user, so that parts can be prevented from being damaged and deformed even when they are repetitively used, thus ensuring reliability of operation.

### Technical Solution

In order to accomplish the above objects, the present invention provides an apparatus for fastening tableware, including: a piece of tableware (105), which is provided with a space in which food is contained; a suction unit (100), which is closely attached to a desk or table (110) using vacuum pressure; a support column (22), which is configured to protrude upwards from the suction unit (100); and a locking unit, which is used to couple the tableware (105) to the support column (22); wherein, when the support column (22) and the tableware (105) are coupled with each other, a difference in vertical position between the tableware (105) and the support column (22) is adjusted so that the tableware (105) is not inclined.

In addition, the present invention provides an apparatus for fastening tableware, including: a piece of tableware (105), which is configured to contain food therein, a counter locking part (10), which is configured to protrude from a side surface of the upper portion of the tableware (105) and to have a rectangular and flat shape; and a suction unit (100), comprising a suction cup (30), which is made of rubber material and is configured such that the lower surface thereof has a circular shape and a pulling bar (41) is formed in an upward direction from the central portion thereof, and a housing (40), which is disposed over the suction cup (30) to contain the suction cup (30) and is provided with an actuation lever (44) for rotating a hinge (43), the suction dick (30) being coupled with the pulling bar (41), a support column (22), which is vertically integrated with a side portion of the housing (40), and a locking part (49), which is configured such that a locking seat (47), having a [symbol] -shape, is formed on a side surface of the support column (22) and a stopper plate 48, having elasticity, is formed on the front surface thereof; wherein the tableware (105) is attached to a desk or table (110) in such a way that the counter locking part (10), which protrudes from the side surface of the tableware (105), is inserted into the locking seat (47) of the locking part (49) and is unlocked using the stopper plate (48), which is coupled to be controlled.

In addition, the present invention provides an apparatus for fastening tableware, including: a counter locking part (10), which is configured to protrude from a side surface of a piece of tableware, in which food is contained, and to be provided with a protrusion (11), which is formed such that one end thereof is extended in two side direction thereof; and a locking stand (20), having a fitting depression (21), which is configured to protrude upwards from the housing (40) of a suction unit (100), which is provided with a circular suction cup (30), which is made of rubber material, below the housing (40), to be bent to have a hook shape in the front thereof, and to fit the counter locking part (10) thereinto, a support column (22), which is formed such that the interior thereof is vacant in a side portion of the fitting depression (21), and a button switch (25), having a [symbol] -shaped section, the button switch (25) constituting the support column (22) and having a button (24), which is formed on the upper surface of the support column (22) through a gap (23); wherein the counter locking part (10) is fitted into the locking stand (20) and, thus, the tableware (105) and the suction unit (100) are integrated with each other, and the suction unit (100) is fastened to a table (110) for the use thereof.

In addition, the present invention provides an apparatus for fastening tableware, including: a counter locking part (110), which is configured to protrude from a side surface of a piece of tableware (205), in which food is contained, and to be provided with a protrusion 111, which is formed such that one end thereof is extended on both sides thereof; a support column (120), which is configured to protrude upwards from the housing (140) of a suction unit (200), which is provided with a circular suction cup 130, which is made of rubber material, below the housing 140; and a locking part (122) having a fitting depression (121), which is configured such that a left and right ends thereof is bent to have a hook shape in one direction of a support column (120), and such that the upper end thereof is closed and the lower end thereof is open to enable the counter locking part (110) to be fitted thereinto; wherein the tableware (205) and the suction unit (200) are integrated with each other by fitting the counter locking part (110) into the locking part (122), and the suction unit (200) is fastened to a table for the use thereof.

In addition, the present invention provides an apparatus for fastening articles, including: a counter locking part, which is provided to protrude from an article and is configured such that one end thereof is extended as both side portions thereof are concaved; and a main body, which is provided with a fitting depression, having a shape that corresponds to that of the counter locking part so that the counter locking part is fitted thereinto in a sliding manner, and is provided with a suction unit on one side of the fitting depression; wherein the main body comprises: a button, which is a member that is mounted in the upper portion thereof to be able to be elastically raised and lowered, and which is provided with tilting guide plates that are formed in the lower end of the button to have respective tilted surfaces, the widths of which is gradually decreased downwards; and an elastic fitting piece, which is a part that is laterally moved by operating in conjunction with the ascending and descending operation of the button, and which is configured such that one end thereof comes into contact with the tilted surfaces of the tilting guide plates and the remaining end thereof protrudes to the upper surface of the counter locking part, which is fitted into the fitting depression, thus preventing the counter locking part from being separated.

In addition, the present invention provides an apparatus for fastening articles, including: a counter locking part, which is provided to protrude from an article and is configured such that one end thereof is extended as both side portions thereof are concaved; and a main body, which is provided with a fitting depression, having a shape that corresponds to that of the counter locking part so that the counter locking part is fitted thereinto in a sliding manner, and is provided with a suction unit on one side of the fitting depression; wherein the main body comprises: a button, which is a member that is mounted in the upper portion thereof to be able to be elastically raised and lowered, and which is provided with tilting guide plates that are formed in the lower end of the button to have respective tilted surfaces, the widths of which is gradually decreased downwards; and an elastic fitting piece, which is a part that is laterally moved by operating in conjunction with the ascending and descending operation of the button, and which constitutes a fitting part, the fitting part being configured such that one end thereof comes into contact with the tilted surfaces of the tilting guide plates and the remaining end thereof is elastically inserted into a position determination depression, which is formed in a portion of the counter locking part, which is fitted into the fitting depression, thus generating locking force.

The characteristics and advantages of the present invention will become more apparent from the following detailed description in conjunction with the accompanying drawings. Prior to reading the detailed description of the present invention, it must be understood that the terms or words used in the specification and claims of the present invention should not necessarily be understood according to their general meanings or dictionary definitions, but should be understood to have meanings and to represent concepts conforming to the technical spirit of the present invention on the basis of the principle by which inventors can define the concept of terms properly to explain their invention in the best way.

### Advantageous Effects

In the present invention, one or more pieces of tableware can be securely fastened to a table using the suction unit, so that the event in which children or toddlers spill food that is contained in their tableware by knocking the tableware over while having a meal can be fundamentally prevented from occurring. As a result, the present invention is useful in that it reduces the cost of providing food.

Furthermore, in the case where adults eat food in a running train or vehicle, the present invention is very useful because it enables the adults to eat food in a stable state in which no vibration occurs.

Furthermore, the present invention is configured such that a stopper protrusion is formed, stopper depressions, into which the stopper protrusion is inserted, are formed, and the stopper protrusion is inserted into any of the stopper depressions, which are arranged with a predetermined pitch therebetween while being moved, so that an auxiliary plate, which enables correction by the pitch, can be used, with the result that the present invention can be applied to a table made of wood, on which the suction unit cannot be used.

Furthermore, in the present invention, secure locking can be stably maintained merely by a user's simple manipulation, by which the counter locking part is fitted into the fitting depression of the main body in a sliding manner, and in particular, damage to the button, attributable to the repetitive use thereof, can be prevented using the structure in which the elastic body is additionally provided in each of the button and the stopper, with the result that the convenience of use of various products, to which the present invention is applied, can be improved.

### BRIEF DESCRIPTION OF THE DRAWINGS

FIG. 1 is an exploded perspective view showing a piece of tableware fastened to a table according to a first embodiment of the present invention;

FIG. 2 is a view showing a modification of FIG. 1;

FIG. 3 is a view illustrating an example of use of the tableware according to the first embodiment of the present invention;

FIG. 4 is a sectional view illustrating a process of detachably attaching the tableware according to the first embodiment of the present invention;

FIG. 5 is a view showing the lower surface of a suction unit according to a first embodiment of the present invention;

FIG. 6 is a view showing the housing of a suction unit according to a second embodiment of the present invention;

FIG. 7 is a bottom view showing the housing of the suction unit according to the second embodiment of the present invention;

FIG. 8 is a plan view showing the housing of the suction unit according to the second embodiment of the present invention;

FIG. 9 is a side view showing the suction unit according to the second embodiment of the present invention;

FIG. 10 is a view showing an example of tableware according to a second embodiment of the present invention;

FIG. 11 is a plan view showing the tableware according to the second embodiment of the present invention;

FIG. 12 is a sectional side view showing the tableware according to the second embodiment of the present invention;

FIG. 13 is a plan view showing the coupling between a piece of tableware according to the second embodiment of the present invention and a suction unit;

FIG. 14 is a sectional view showing the coupling between the tableware according to the second embodiment of the present invention and the suction unit;

FIG. 15 is a plan view showing the coupling between the tableware according to the second embodiment of the present invention and the suction unit;

FIG. 16 is a sectional view showing the coupling between the tableware according to the second embodiment of the present invention and the suction unit;

FIG. 17 is a plan view showing a piece of tableware and a suction unit, according to the present invention;

FIG. 18 is a sectional view showing the tableware and the suction unit, according to the present invention;

FIGS. 19 to 21 are views showing tableware according to another embodiment of the present invention;

FIG. 22 is a plan view showing the coupling between the tableware of the present invention and a suction unit;

FIG. 23 is a sectional view showing the coupling between the tableware of the present invention and the suction unit;

FIG. 24 is a view showing the coupling between two pieces of tableware and a suction unit, according to the present invention;

FIG. 25 is a view showing the coupling between four pieces of tableware and a suction unit, according to the present invention;

FIG. 26 is a sectional view showing another embodiment of the present invention;

FIG. 27 is a sectional view showing a piece of tableware and a tableware fastening apparatus, according to another embodiment of the present invention;

FIG. 28 is a view showing a structure in which a locking part can be rotated, according to the present invention;

FIG. 29 is a sectional view showing the state in which a pushing plate is formed in the locking part of the present invention;

FIG. 30 is a perspective view showing a tableware fastening apparatus according to a third embodiment of the present invention;

FIG. 31 is an exploded perspective view showing the suction unit coupling apparatus of FIG. 30;

FIG. 32 is a sectional view illustrating the internal construction of FIG. 30;

FIGS. 33 and 34 are sectional views illustrating the locking structure of the locking part of FIG. 30;

FIGS. 35 to 37 are perspective views illustrating operational relationships between a button and an elastic fitting piece in FIG. 30;

FIG. 38 is a perspective view showing a modification of the tableware fastening apparatus of FIG. 30;

FIG. 39 is a sectional view illustrating the construction of the tableware fastening apparatus of FIG. 38; and

FIGS. 40 and 41 are views showing a modification of a protrusion.

### DESCRIPTION OF CHARACTERS OF PRINCIPAL ELEMENTS

1: coupling apparatus 3: main body

3′: fitting depression 3a: seating depression

3as: holding pin 3h: horizontal mounting hole

5: counter locking part

5h: position determination depression

7: suction unit 10: counter locking part

11: protrusion 10b: button

11b: pushing part 12: stopper protrusion

13: tilting guide plates

15: lifting guide plates

20: locking stand

21: fitting depression

22: support column 23: gap

24: button 25: button switch

26: stopper depressions 30: suction cup

30t: elastic fitting piece

31: fitting part

33: actuation support columns

40: housing 41: pulling bar

43: hinge 44: actuation lever

47: locking seat 48: stopper plate

49: counter locking part 70: auxiliary plate

s1: vertical elasticity body 105: tableware

110: table 100: suction unit

### MODE FOR THE INVENTION

The above and other objects, features and advantages of the present invention will be more apparent from the following detailed description.

Tableware according to the present invention is similar to conventional tableware in that it is used to have a meal, but is characterized in that a suction unit is separately provided such that the tableware can be attached to a table for the use thereof, thus preventing valuable food from being spilt by knocking the tableware over in any situation. Thus, a preferred embodiment of the present invention is described with reference to the accompanying drawings below.

First, it should be noted that the same reference numerals are used throughout the different drawings to designate the same or similar components. In the description of the present invention, descriptions of related well-known functions or constructions are omitted so as not to make the gist of the present invention unclear.

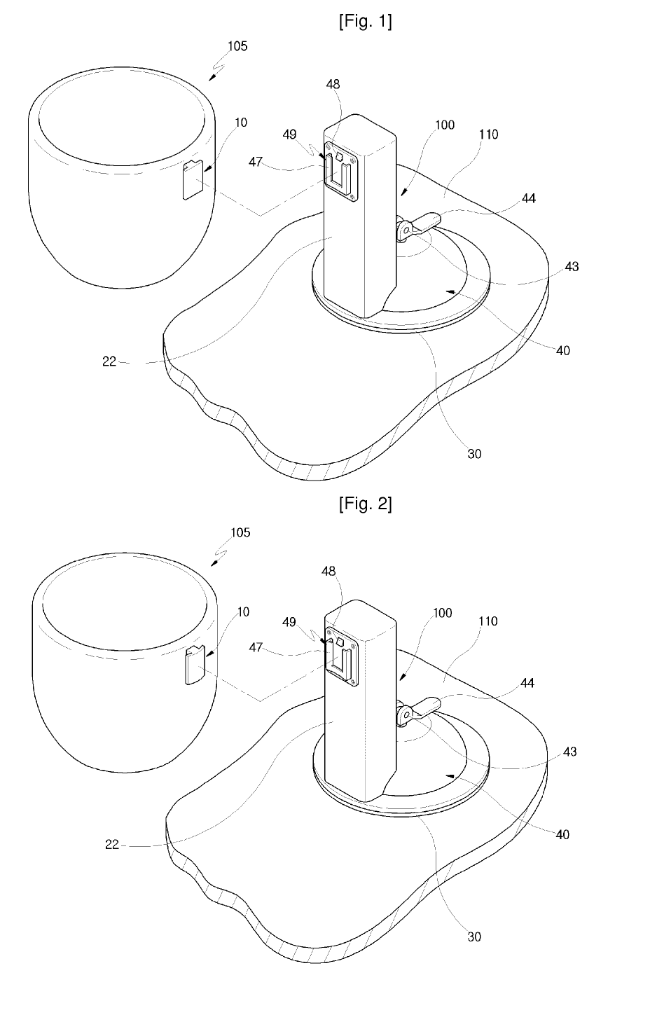

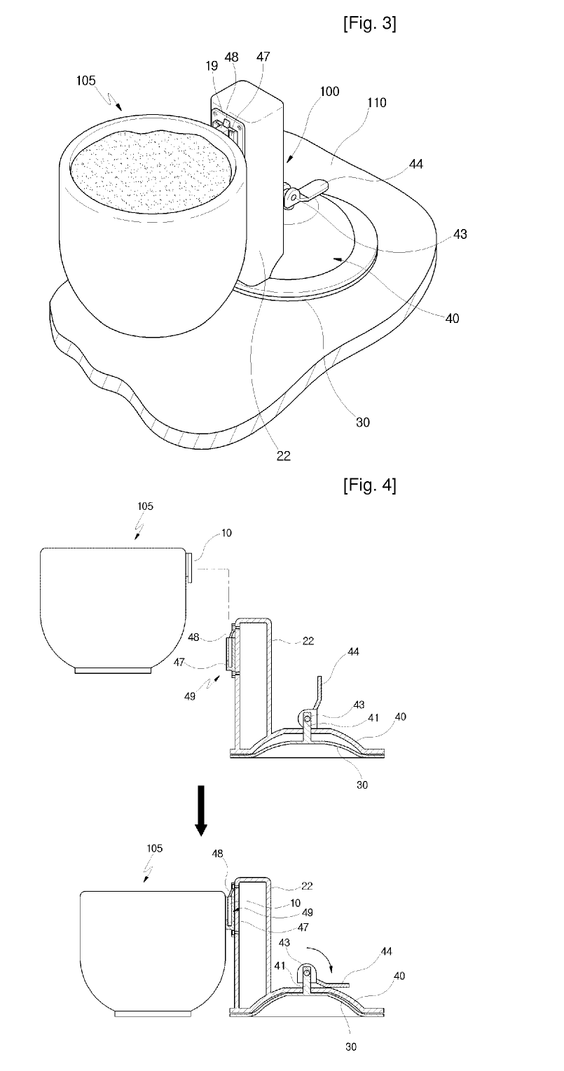

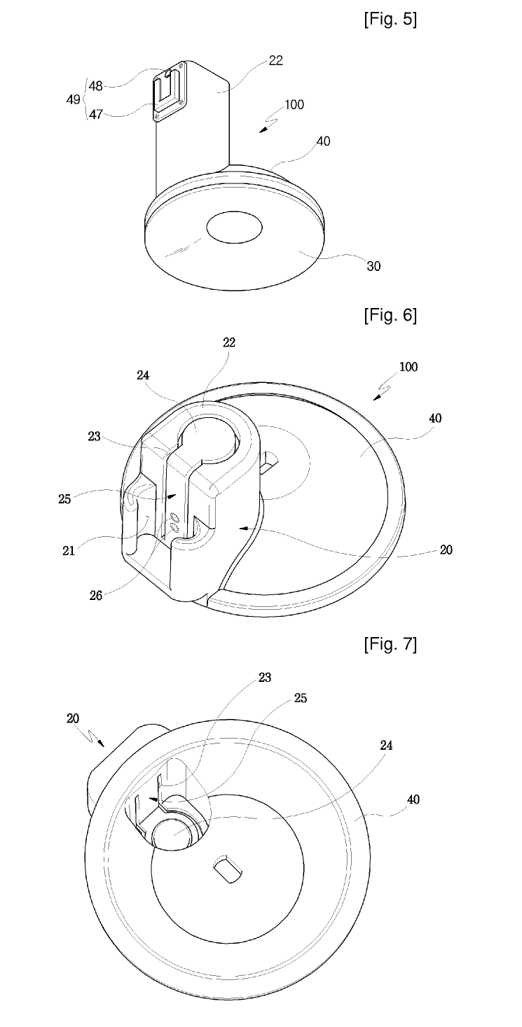

FIG. 1 is an exploded perspective view showing a piece of tableware fastened to a table according to a first embodiment of the present invention, FIG. 2 is a view showing a modification of FIG. 1, FIG. 3 is a view illustrating an example of use of the tableware according to the first embodiment of the present invention, FIG. 4 is a sectional view illustrating a process of detachably attaching the tableware according to the first embodiment of the present invention, and FIG. 5 is a view showing the lower surface of a suction unit according to a first embodiment of the present invention.

As shown in FIGS. 1 to 5, the present invention includes a piece of tableware 105, which is provided with a space in which food is contained, a suction unit 100, which is closely attached to a desk or table 110 using vacuum pressure, and a support column 22, which is configured to protrude upwards from the suction unit 100. Furthermore, a locking unit, which is used to lock the tableware 105 to the support column 22, is provided. Accordingly, when the support column 22 and the tableware 105 are locked with each other using the locking unit, the difference in vertical position between the tableware 105 and the support column 22 is adjusted so that the tableware 105 is not inclined.

That is, the present invention includes a typical piece of tableware 105 and the suction unit 100. For example, well-known suction units, which are attached to the surface of a glass plate using vacuum, formed by suction, and is used when lifting and carrying the glass plate, may be used for the suction unit 100. That is, in addition to the above-described suction units, the technical spirit of the suction unit may be adopted to the present invention. In greater detail, the present invention is securely attached to the top of the table 110 using the suction unit 100. In this case, the support column 22 is formed in the side portion of the suction unit 100. Furthermore, the locking unit, which is used to lock the tableware 105 to the support column 22, is provided. In this case, this locking unit may be implemented using any well-known locking structure, which can be detachably attached. Accordingly, the tableware 105 and the support column 22 of the suction unit 100 can be detachably attached at any time when needed. As a result, the location of the tableware 105, which is locked to the suction unit that is closely attached to the table 110, is not changed such that the tableware 105 is not knocked over and food contained in the tableware 105 is not spilt.

Next, the present invention is described in detail with reference to the embodiment, shown in FIGS. 1 to 5, below.

The apparatus for fastening tableware, the tableware being used to have a meal, includes the tableware 105, which is configured to contain food therein, and a counter locking part 10, which is configured to protrude from a side surface of the upper portion of the tableware 105 and to have a rectangular and flat shape. Furthermore, the apparatus includes a suction unit 100, having a suction cup 30, which is made of rubber material and is configured such that the lower surface thereof has a circular shape and a pulling bar 41 is formed in the upward direction from the central portion thereof, and a housing 40, which is disposed over the suction cup 30 to contain the suction cup 30 and is provided with an actuation lever 44 for rotating a hinge 43, the suction dick 30 being coupled with the pulling bar 41, a support column 22, which is vertically integrated with the side end of the housing 40, and a locking part 49, which is configured such that a locking seat 47, having a [symbol] -shape, is formed on a side surface of the support column 22 and a stopper plate 48, having elasticity, is formed on the front surface thereof. Accordingly, the tableware 105 can be attached to the desk or table 110 in such a way that the counter locking part 10, which protrudes from the side surface of the tableware 105, is fitted into the locking seat 47 of the locking part 49 and is unlocked using the stopper plate 48, which is coupled to be controlled.

That is, in the present invention, various tableware 105 having a circular shape may be used as shown in FIG. 1. Furthermore, tableware 105, having a rectangular shape or other shapes, may be used. Furthermore, the counter locking part 10, shown in the drawing, is coupled to the side surface of the tableware 105 in an integrated or separated manner, and has a rectangular shape. That is, a flat plate is vertically coupled and has a rectangular shape. Furthermore, the suction unit 100, shown in the drawing, is provided on one side of the tableware 105.

The suction unit 100 includes the suction cup 30, which is made of rubber material, and the housing 40, which contains the suction cup 30 over the suction cup 30. Furthermore, the actuation lever 44, which is operated in the left and right directions around the hinge 43, is coupled to the upper portion of the housing 40. In this case, the pulling bar 41, which is integrally and vertically coupled to the central portion of the suction cup 30, is coupled to the actuation lever 44, so that, when the actuation lever 44 is pushed and inclined in one direction, the actuation lever 44 cause only the central portion of the suction cup 30 to be raised by pulling the pulling bar 41. Subsequently, the central portion of the suction cup 30 is pulled and raised in the state in which the circumferential surface of the suction cup 30 is closely attached to the table 110, and thus the interior of the suction cup 30 enters in a vacuum state. That is, vacuum pressure works. The suction unit 100 of the present invention is securely attached and fastened to the table using such vacuum pressure.

Furthermore, as shown in the drawings, the suction unit 100 of the present invention has the support column 22 in a side portion of the housing 40. This support column 22 is manufactured to be vertically placed on the housing 40. In this case, the locking part 49 is formed on the side surface of the support column 22. The locking seat 47 of the locking part 49 is located to have a [symbol] -shape. A space and a gap are formed in the locking part 49. Accordingly, the counter locking part 10 is pushed into the gap, and is maintained in a state in which it is held in the space. Furthermore, in order to prevent the holding state from being released, the stopper plate 48 is formed on the entrance side of the locking seat 47, into which the counter locking part 10 is fitted. This stopper plate 48 functions to prevent the counter locking part 10 from being pushed and ejected because the end thereof is raised, but allows the counter locking part 10 to be pushed out because the end thereof is pushed in when a user presses it

Accordingly, in the present invention, integration is realized in such a way as to push the counter locking part 10, which is formed in the tableware 105 into the locking part 49, which is formed on the support column 22. In the integrated state, described above, when the suction unit 100 is closely attached to the table 110, the effect in which the tableware 105 is coupled to the table 110 is brought, and thus the food is prevented from being spilt even when any shaking occurs.

In the present invention, the shapes of the counter locking part 10 of the tableware 105 and the locking part 49 of the suction unit 100 may be changed according to shape of the tableware 105. That is, when a piece of tableware 105 having a circular shape is used, it is preferred that the counter locking part 10 and the locking part 49 be formed to be rounded like the side surface of the tableware 105.

That is, as shown in FIG. 2, the counter locking part 10 is formed to be rounded in the same manner as in the rounded side surface of the tableware 105, and the locking seat 47 of the locking part 49 of the suction unit 100 and the stopper plate 48 are also manufactured to have a slightly rounded shape. Here, the reason why the counter locking part 10 and the locking seat 47 are manufactured to have the same sectional shape is because the counter locking part 10 can be locked to the locking seat 47 while being guided.

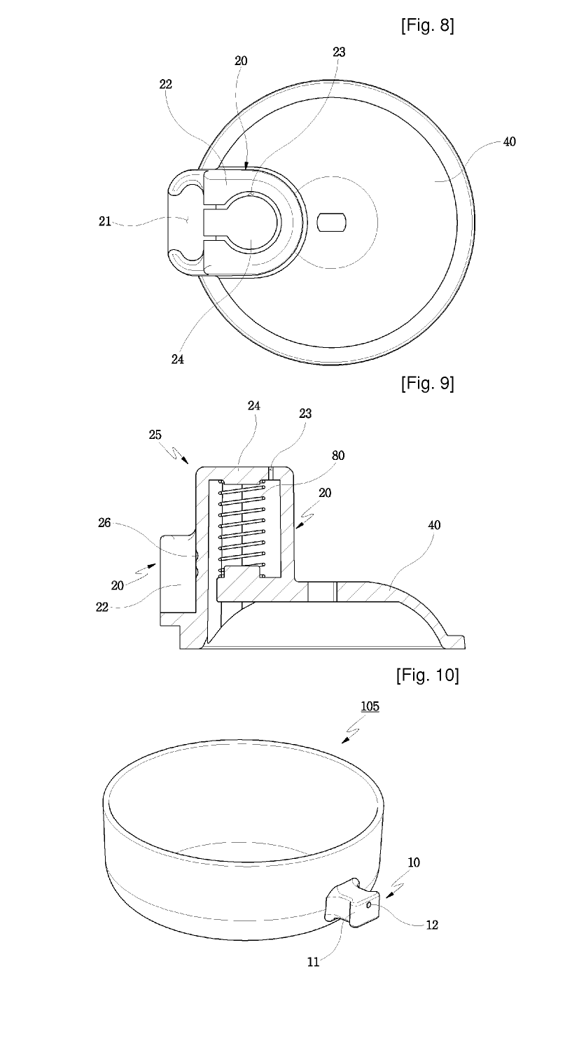

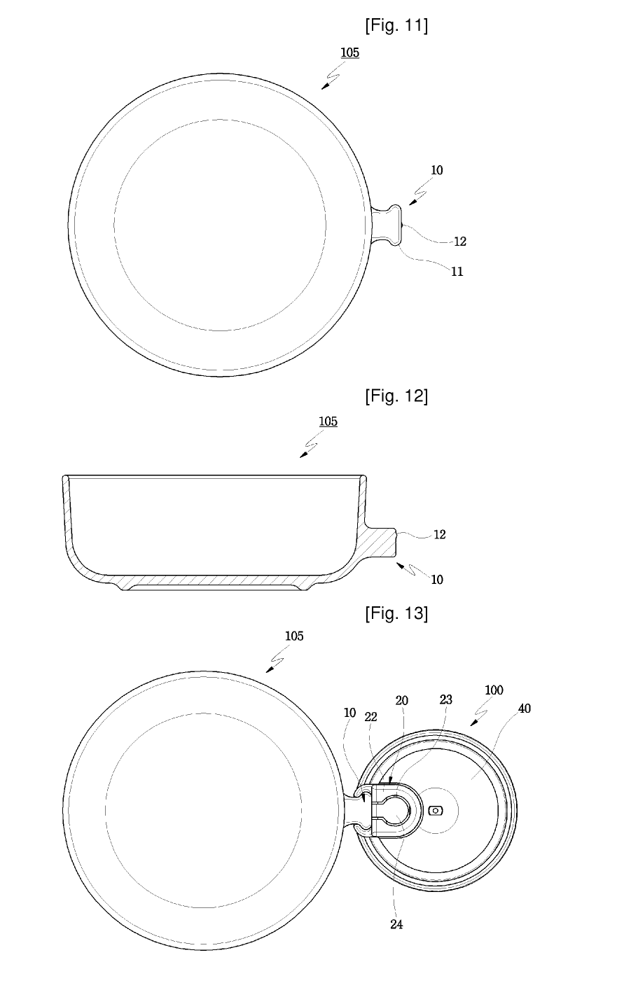

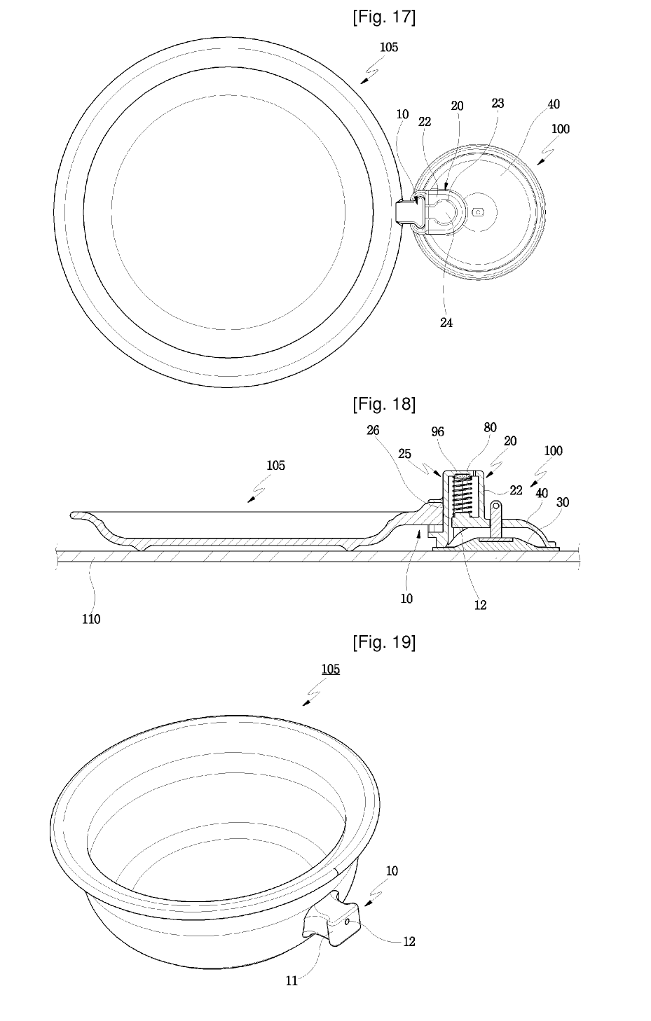

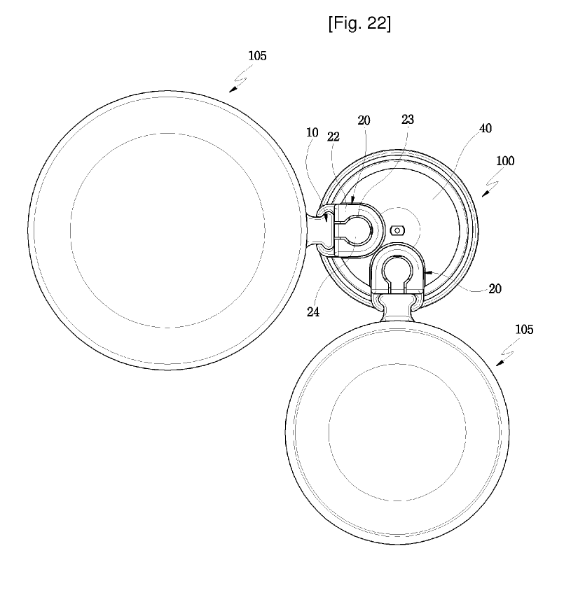

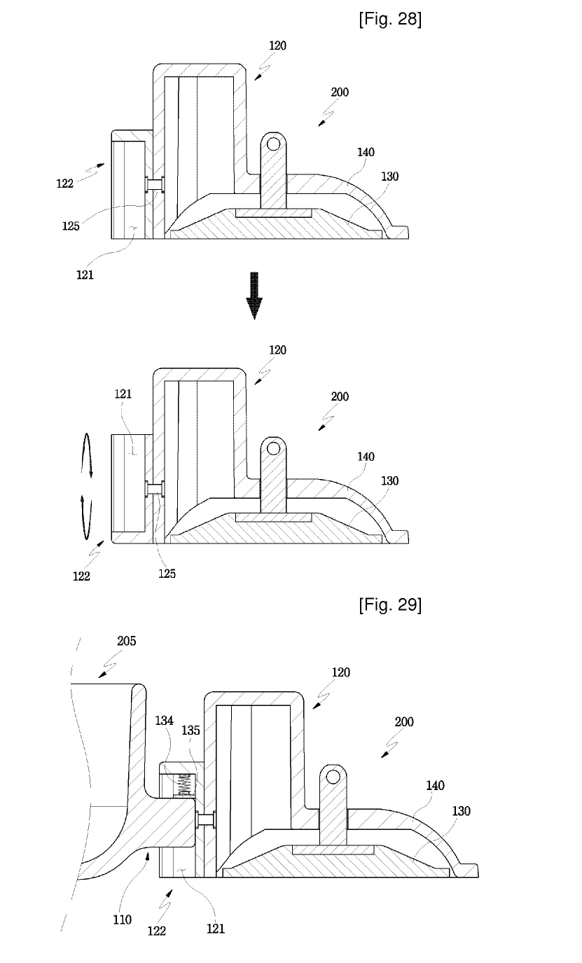

A tableware fastening apparatus according to a second embodiment of the present invention is described with reference to FIGS. 6 through 29.

As shown in the drawings, the tableware fastening apparatus includes a counter locking part 10, which is configured to protrude from a side surface of a piece of tableware, in which food is contained, and to be provided with a protrusion 11, which is formed such that the end thereof is extended on both sides thereof, and a locking stand 20, having a fitting depression 21, which is configured to protrude upwards from the housing 40 of a suction unit 100, which is provided with a circular suction cup 30, which is made of rubber material, below the housing 40, to be bent to have a hook shape in the front thereof, and to fit the counter locking part 10 thereinto, a support column 22, which is formed such that the interior thereof is vacant in the side portion of the fitting depression 21, and a button switch 25, having a [symbol] -shaped section, the button switch 25 constituting the support column 22 and having a button 24, which is formed on the upper surface of the support column 22 through a gap 23. Accordingly, the counter locking part 10 is fitted into the locking stand 20 and, thus, the tableware 105 and the suction unit 100 are integrated with each other, and the suction unit 100 is fastened to a table 110 for the use thereof.

That is, in the present invention, the counter locking part 10, shown in FIG. 10, is integrally formed on the side surface of each of pieces of table ware 100, such as various bowls and vessels, that are used to have a meal and drink beverages. A stopper protrusion 12 is formed on the front surface of the counter locking part 10. In this case, the stopper protrusion 12 protrudes in a semi-circular shape and is coupled with a corresponding stopper depression 26, which is any of stopper depressions 26 that are formed in a side surface of the button switch 25 of the support column 22, thus helping the tableware 105 securely and detachably attached thereto. Furthermore, the construction that corresponds to the counter locking part 10 of the tableware 105 is the locking stand 20 of the suction unit 100. That is, the locking stand 20 is integrally formed on the housing 40 of the suction unit 100, which can be fastened to the flat table 110 in an air suction manner using the suction cup 30. In this case, it is most preferred that the locking stand 20 be manufactured through injection molding. Furthermore, the locking stand 20 includes the support column 22, the fitting depression 21, and the button switch 25, which constitutes the support column 22. That is, the locking stand 20 is formed to protrude upwards from the housing 40. In this case, the fitting depression 21, which corresponds to the counter locking part 10 of the tableware 105, is formed in the most outer portion of the housing 40. In this case, the fitting depression 21 is configured such that the upper portion and the front surface thereof are open, so that, when the counter locking part 10 of the tableware 105 is fitted downwards thereinto, the counter locking part 10 is inserted into the fitting depression 21 in a sliding manner, thus the tableware 105 and the suction unit 100 are locked to each other.

In other words, the counter locking part 10 is in the state in which the end thereof is extended on both sides thereof, and the fitting depression 21, into which the counter locking part 10 is fitted, is in the state in which the ends thereof are bent inwards, so that the counter locking part 10 is locked to the fitting depression 21, thus not being easily ejected. Furthermore, in the locking state, described above, the stopper protrusion 12, which protrudes from the front surface of the counter locking part 10, is inserted into any of the stopper depressions 26, which are formed in the side surface of the button switch 25, which constitutes the support column 22. Accordingly, a locking structure that is not easily ejected is achieved.

As a result, it is a preferred embodiment that the stopper protrusion 12, which protrudes from the front surface of the counter locking part 10, is formed on the stopper protrusion 12, and the stopper depressions 26, into which the stopper protrusion 12 is inserted, are formed in the side surface of the button switch 25.

Furthermore, as shown in FIG. 6, a part of the support column 22, constructs the button switch 25. That is, this button switch 25 has a [symbol] -shaped section, and the button 24, which is formed in the upper end of the button switch 25, forms the upper surface of the support column 22. Accordingly, when the user presses the button 24, the button 24 is pressed, so that the [symbol] -shaped button switch 25 is pressed and is thus laterally inclined while the gap 23 is narrowed. In this case, when the stopper depressions 26, which are formed in the button switch 25, are ejected from the stopper protrusion 12, which is formed on the counter locking part 10 of the tableware 105, in response to such an operation, the user can easily separate the tableware 105 from the suction unit 100.

As a result, the present invention has a locking structure in which the counter locking part 10 is formed on the tableware 105, and the locking stand 20 is configured such that the counter locking part 10 is detachably attached to the suction unit 100. Accordingly, in the case where children and toddlers use the present invention, the tableware 105 can be actually prevented from being separated from the table 110 by fastening the suction unit 100 to the table 110 in a suction manner and locking the the tableware 105 to the suction unit 100. In the case where the tableware 105 is fastened to the table 110, the events that the food, which is contained in the tableware 105, is spilt can be prevented from occurring even when the children severely play with the food while having a meal.

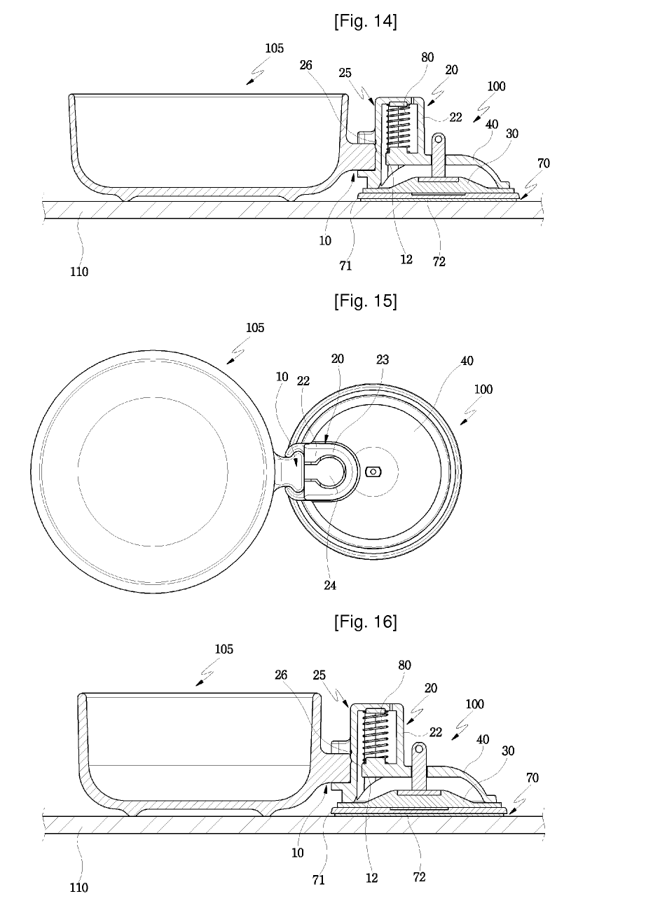

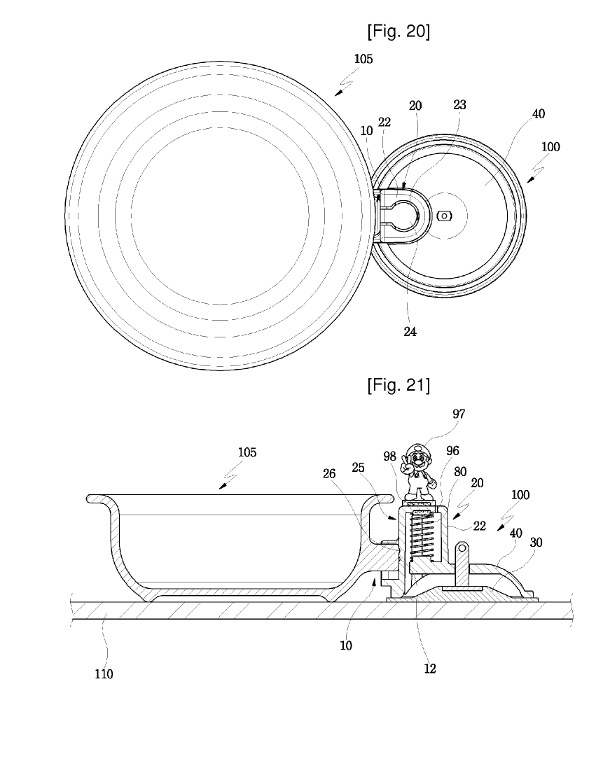

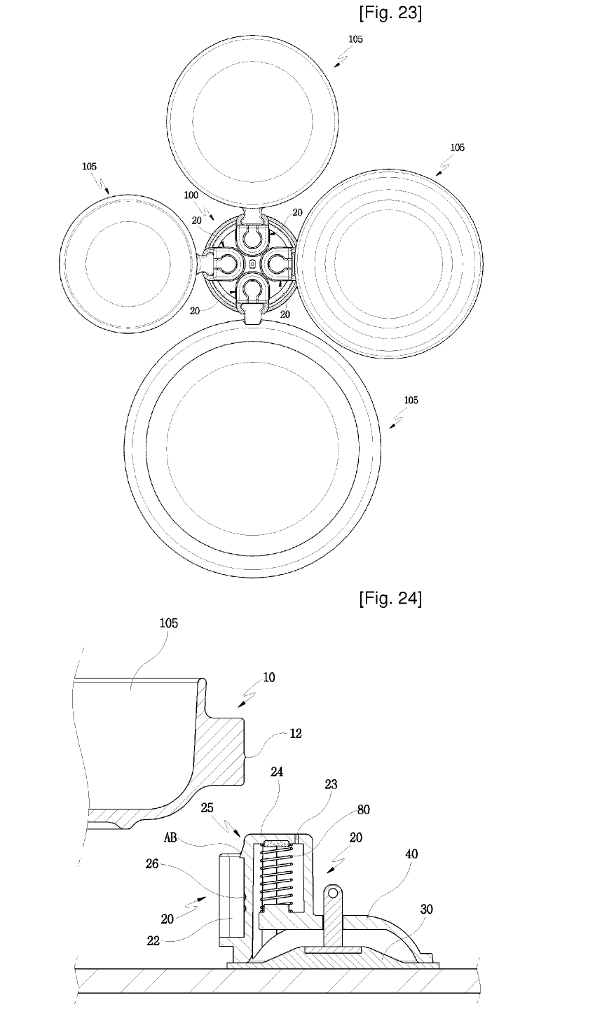

Meanwhile, in the present invention, it is preferred that an auxiliary plate 70, which includes a circular plate 71, which is formed to have a diameter greater than that of the suction unit 100, having a circular shape, and a double-sided tape 72, which is adhered to the lower surface of the circular plate 71, be coupled to the lower surface of the suction unit 100, thus enabling use for a table 110, for which the suction method cannot be used. That is, the table 110 may be actually manufactured in various ways using material, such as glass, synthetic resin, wood or metal material. Furthermore, the surface of the table 100 may be coated in various ways, or there is a table 110 that is manufactured such that the natural texture thereof is maintained. In addition, the table 110 may be manufactured in such a way as to form a pattern by processing the surface of the table 110 and apply paint thereto, or may be formed in a prominence and depression manner. Accordingly, there is a possibility in which the suction unit 100 of the present invention does not work. That is, the suction unit 100 is a part that is overall closely attached to a flat surface, thus enabling the coupling with the table 110 in such a way as to evacuate the internal air thereof. However, in the case of a table 110, which is made of wood and the surface of which is not coated, in the case of a table, the surface of which is formed to have a pattern in a prominence and depression manner, or in the case of a table 110, the surface of which is not flat, no coupling to the table 110 can be made using the suction unit 100. Accordingly, in the present invention, the auxiliary plate 70 is formed as a provision against such cases, as shown in FIGS. 14 to 16. The present invention uses a method of adhering the auxiliary plate 70 to the table 110 using the double-sided tape 72, which is formed on the lower surface of the auxiliary plate 70, and coupling the suction unit 100 to the upper surface of the auxiliary plate 70, so that the suction unit 100 can be fastened regardless of the quality, flatness surface conditions of the table 110. In the case of the auxiliary plate 70, it is apparent that the surface thereof must be made of material, which enables the sufficient suction and coupling of the suction unit 100. Accordingly, in the present invention, the plurality of stopper depressions 26 is formed in the button switch 25 because the above-described auxiliary plate 70 is necessary. That is, if the method of adhering the auxiliary plate 70 to the table 110 and coupling the suction unit 100 to the upper surface of the auxiliary plate 70 is used, the suction unit 100 may be raised by the thickness of the auxiliary plate 70. In this case, the coupling heights of the suction unit 100 and the counter locking part 10, which is formed on the tableware 105, do not coincide with each other. In the present invention, in order to solve this problem, the plurality of stopper depressions 26 is formed in the button switch 25. Accordingly, the stopper depressions 26 are selectively used according to whether the auxiliary plate 70 is used, as shown in FIGS. 14 to 16 and in FIG. 20. In other words, when the suction unit 100 is applied to a table 110, which can be used without requiring the auxiliary plate 70, the stopper protrusion 12 is coupled to the upper stopper depression 26, as shown in FIGS. 20 and 23, whereas, when the suction unit 100 is applied to a table 110, which is made of wood and which requires the use of the auxiliary plate 70, the stopper protrusion 12 is coupled to the lower stopper depression 26, as shown in FIGS. 14 to 16 and in FIG. 18.

Furthermore, in the present invention, it is preferred that the locking stand 20 be configured such that an elastic spring 80 for supporting the button switch 25 is mounted in the support column 22. The button switch 25 of the present invention has a [symbol] -shaped section, is formed through the gap 23, which exists around the button switch 25, and itself has elasticity because the end thereof is integrated with the support column 22, thus actually having a restoring characteristic when pressing force is eliminated. In the present invention, the elastic spring 80 is mounted in the button switch 25, so that the above-described working can be more definitely ensured. Here, the elastic spring may be implemented using any well-know elastic spring, such as a spring having a circular section, a plate-type spring, or a spring using air cushion.

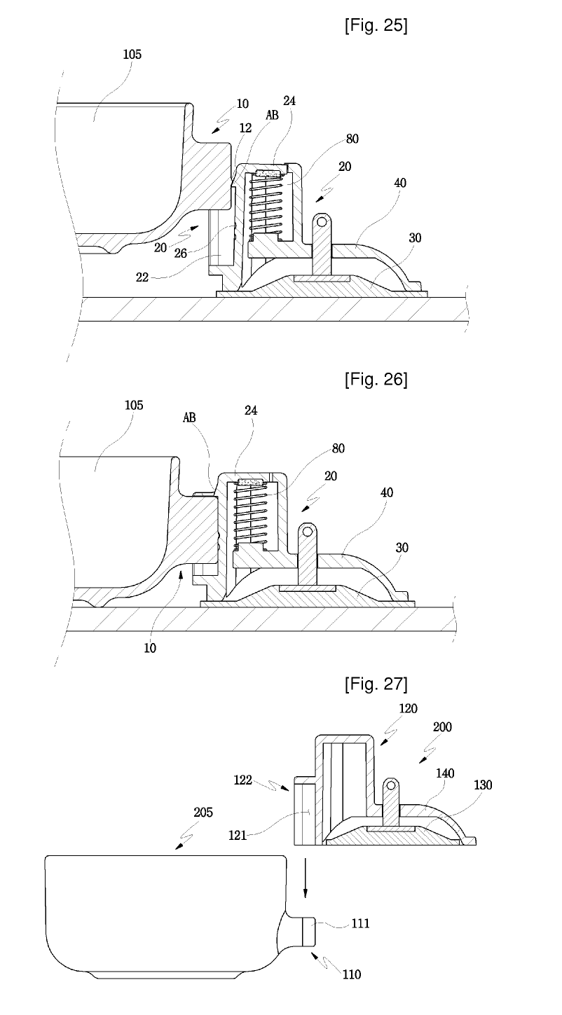

Furthermore, the locking stand 20 of the present invention may be configured such that one to four locking stands are formed on the housing 40 of the suction unit 100. That is, as shown in FIGS. 24 and 25, a plurality of locking stands 20 may be formed on the suction unit 100 so that a plurality of pieces of tableware 105 can be locked thereto. That is, in the case where having a meal is conducted on the table 110, a plurality of pieces of tableware 105, such as a rice bowl, a soup bowl and a dish bowl, may be locked to a single suction unit 100 for the use thereof.

Furthermore, in the present invention, as shown in FIG. 23, a separate magnet 96 is applied to the button 24 of the support column 22, thus enabling detachable attachment of a character doll 97 thereto. This is to increase children's power of concentration for a mealtime and remain in their memory as an enjoyable mealtime because the most of persons who use such tableware are the children. In this case, it is apparent that a separate magnet 96, or a metal plate, must be provided in the lower end of the doll 97 so that the magnetic force of the magnet 96 can act on the doll 97.

Furthermore, the present invention has an auxiliary locking function of preventing a piece of tableware from being easily ejected from the locking stand of the suction unit when the tableware is fitted into the locking stand of the suction unit. This embodiment is shown in FIG. 26. That is, a locking part AB is formed on the side surface of the button switch 25 and is located above the stopper depressions 26. Accordingly, the locking part AB, which has a shape similar to an arrowhead, functions as a stopper when the counter locking part 10 of the tableware 105 is fitted, but the counter locking part 10 is not easily ejected from the fitting depression 21 because it is locked by the locking part AB when releasing the counter locking part 10. In this case, the tableware 105 can be easily ejected in the state in which the locking part AB is moved backwards by pressing the button switch 25.

Next, FIGS. 27 to 29 show a tableware fastening apparatus according to another embodiment of the present invention. This embodiment is characterized in that it is formed such that the counter locking part of the tableware is fitted upwards, rather than being fitted downwards.

That is, the present invention includes a counter locking part 110, which is configured to protrude from a side surface of a piece of tableware 205, in which food is contained, and to be provided with a protrusion 111, which is formed such that the end thereof is extended on both sides thereof, and a support column 120, which is configured to protrude upwards from the housing 140 of a suction unit 200, which is provided with a circular suction cup 130, which is made of rubber material, below the housing 140. Furthermore, the present invention includes a locking part 122 having a fitting depression 121, which is configured such that the left and right ends thereof is bent to have a hook shape in one direction of the support column 120, and such that the upper ends thereof is closed and the lower end thereof is open to enable the counter locking part 110 to be fitted thereinto. Accordingly, the tableware 205 and the suction unit 200 are integrated with each other by fitting the counter locking part 110 into the locking part 122, and the suction unit 200 is fastened to a table for the use thereof.

That is, the counter locking part 110 is manufactured to be formed on the side surface of the tableware 205, and the suction unit 200, which corresponds to the counter locking part 110, is manufactured. In this case, the locking part 122 is configured such that the counter locking part 110 can be fitted thereinto. The locking part 122 has the fitting depression 121, the lower end of which is open as in FIG. 20. In case of the fitting depression 121, the left and right ends thereof is bent to have a hook shape, so that, once the counter locking part 110, having the protrusion 111 formed on both sides thereof, is fitted into the fitting depression 121, the counter locking part 110 is not easily ejected. The important point is that, unlike the above-described embodiment, the locking of the tableware 205 is achieved by fitting the suction unit 200 downwards, rather than by fitting the suction unit 200 upwards, in the state in which the tableware 205 is placed on a table the suction unit 200. In greater detail, locking is performed in such a way that the suction unit 200 is moved downwards in the state in which the tableware 205 is placed on a table, and thus the counter locking part 110 of the tableware 205 is fitted into the fitting depression 121 of the locking part 122, which is formed on one side of the support column 120 of the suction unit 200. This is possible because the lower end of the locking part 122 is in an open state. If any food is charged in the tableware 205, the locking enables the food not to be spilt.

Here, the locking part 122 may be manufactured in an integrated manner or in a detachably attachment manner, or may be manufactured to be able to rotate. That is, the locking part 122 may be manufactured to be integrated with the support column 120, or may be manufactured to be able to rotate around a hinge 125. When the locking part 122 is integrated with the support column 120 using injection molding, there is an advantage in that the manufacture thereof becomes easy. In contrast, when a separate locking part 122 is manufactured in the form of a block and is integrated with support column 120 using a hinge 125, the separate locking part 122 can rotate around the hinge 125, so that the upper and lower ends of the separate locking part 122 can be selectively open. That is, the separate locking part 122 can be appropriately adjusted to be open as needed. When it is intended to lock the suction unit 200 to the tableware 205, which is placed on a table, by fitting downwards, the lower end of the locking part 122 is located to be open. In contrast, when it is intended to lock the tableware 205 to the suction unit 200, which is fastened to the table, by fitting downwards, locking is made in the state in which the upper end of the locking part 122 is open by rotating the locking part 122 of the support column 120.

However, if only the above-described constructions exist, there is a possibility in which the tableware 205 may be shaken upwards and downward even though the counter locking part 110 is fitted into the locking part 122. That is, a problem with stable fastening to the table may occur because a space in which the counter locking part 110 can move exists in the locking part 122. Accordingly, in order to solve this problem, the present invention proposes another embodiment. That is, a pushing plate 135, which is fastened to a downward-biasing elastic spring 134, is formed in the fitting depression 121, which is formed in the locking part 122, as shown in FIG. 29. Accordingly, the pushing plate 135, which moves downward using elasticity, presses the counter locking part 110 tenderly in the fitting depression 121, the upper end of which is closed, and thus the stable fastening of the tableware 205 can be achieved.

This structure may be formed in the integration-type locking part 122, and may also be formed in the rotation-type locking part 122, in which the hinge 125 is formed. The pushing plate 135, which presses the counter locking part 110 tenderly downwards from the upper end of the fitting depression 121 of the locking part 122 in order to prevent the counter locking part 110 from moving upwards in the state in which the counter locking part 110 is fitted into the locking part 122, presses the locking part 122, thus enabling more stable seating.

The locking structure of a suction unit according to a third embodiment of the present invention is described below with reference to the accompanying drawings, that is, FIGS. 33 to 39.

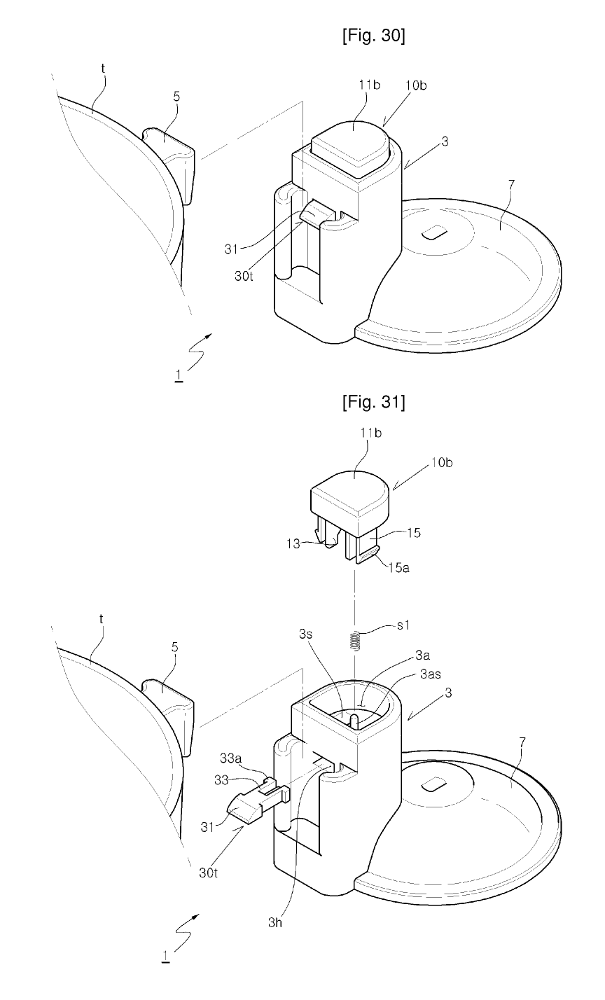

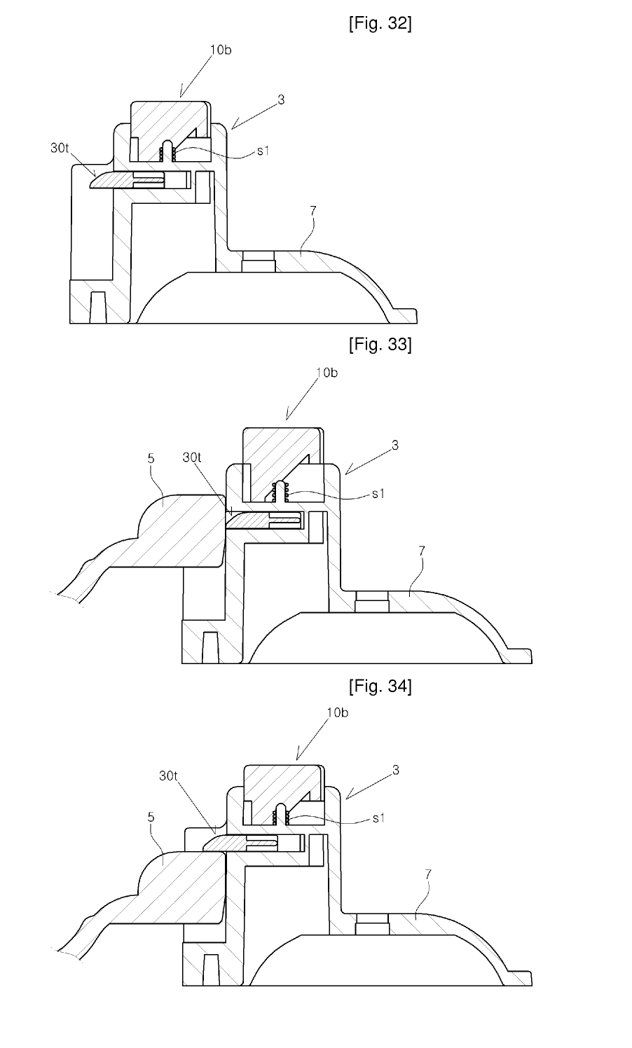

FIG. 30 is a perspective view showing a tableware fastening apparatus according to a third embodiment of the present invention, FIG. 31 is an exploded perspective view showing the tableware fastening apparatus of FIG. 30, and FIG. 32 is a sectional view illustrating the internal construction of FIG. 30.

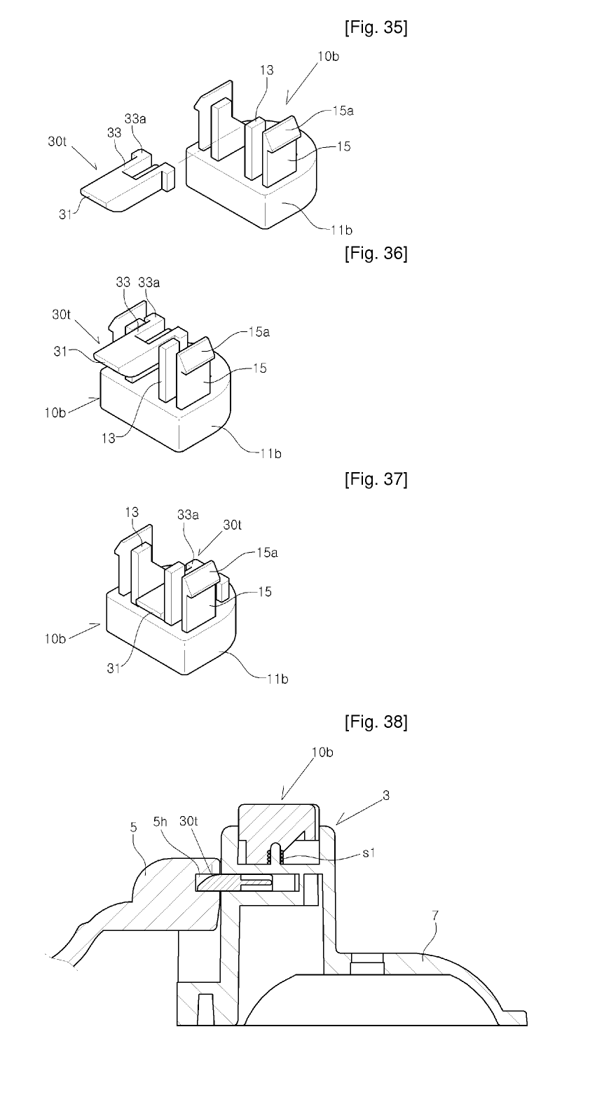

FIGS. 33 and 34 are sectional views illustrating the locking structure of a locking part, and FIGS. 35 to 37 are perspective views illustrating operational relationships between a button and an elastic fitting piece in the tableware fastening apparatus according to the present invention.

As shown in the drawings, the tableware fastening apparatus of the present invention includes a main body 3, which is provided with a suction unit 7, and a counter locking part 5, which is configured to be selectively locked to the main body 3 and is integrated with or attached to various articles t, such as tableware. The main body 3 is provided with a fitting depression 3′ so that the counter locking part 5 can be vertically fitted thereinto in a sliding manner. In this case, the fitting depression 3′ has a shape that corresponds to that of the counter locking part 5, so that the counter locking part 5 can be fitted thereinto. Although, in the present invention, the counter locking part 5 has been shown as being configured such that the end thereof is extended as both side portions thereof are concaved, the counter locking part 5 may be modified to have various shapes if the location thereof can be restricted in the remaining directions except for the assembly direction of the counter locking part 5 when the counter locking part 5 is fitted into and assembled with the fitting depression 3′ in a sliding manner.

The main body 3 is provided to have the shape of a hollowed column, and the well-known suction unit 7 is provided on one side of the main body 3. The above-described main body 3 includes a button 10b, which is provided in the upper portion of a body (the reference number is not shown), and an elastic fitting piece 30, which is provided to protrude on the side of the fitting depression 3′ of the body.

The button 10b is a member that is provided to be seated in a seating depression 3a, which is formed in the main body 3, and to be able to be raised and lowered, and is selectively lowered when it is pressed by the user. As shown in the drawings, the above-described button 10b has a structure in which a pushing part 11b, the upper surface of which is flat so that the user can press it using his or her finger, is provided, and tilting guide plates 13 and lifting guide plates 15, which are board types, are provided to protrude vertically in the downward direction of the pushing part 11b.

Here, the tilting guide plates 13 are parts that cause the elastic fitting piece 30t to be laterally moved by actuating the elastic fitting piece 30t, which will be described later, in response to the ascending and descending operation of the main body 3. As shown in the drawings, the above-described tilting guide plates 13 are formed to have respective tilted surfaces, the widths of which are gradually decreased downwards. Furthermore, the lifting guide plates 15 are parts that support the button 10b so that the button 10b can be stably raised and lowered in the main body 3. Locking projections 15a are formed in the respective ends of the lifting guide plates 15 in order to prevent the button 10b from being released from the main body 3.

Furthermore, the button 10b is configured to be affected by elastic ascending support force, caused by a vertical elasticity body s1.' For this purpose, the seating depression 3a is configured such that a holding pin 3as protrudes from the center portion of the bottom thereof and the holding pin 3as and a vertical elasticity body s1,' which has the shape of a coil spring, is provided around the holding pin 3as. Meanwhile, although, in the present invention, the coil spring is exemplified as a preferred embodiment of the vertical elasticity body s1,' various types of springs may be used.

Meanwhile, it is preferred that a pair of tilting guide plates 13 be provided. The lifting guide plates 15 are located on the respective sides of the tilting guide plates 13.

Reference character 3s indicates a slot that is formed in the bottom of the seating depression 3a so that a single tilting guide plate 13 and a single lifting guide plate 15, which are arranged close to each other, can be inserted thereinto and passes therethough.

The elastic fitting piece 30t is a part that is laterally moved by operating in conjunction with the ascending and descending operation of the above-described button 10b, thus generating a force for locking the counter locking part 5, which is fitted into the fitting depression 3′ of the main body 3, and is laterally moved by operating in conjunction with the ascending and descending operation of the button 10b when the ends of the elastic fitting piece 30t come into contact with the respective tilted surfaces of the tilting guide plates 13. The above-described elastic fitting piece 30t is a part that is inserted into a horizontal mounting hole 3h, which is formed in the fitting depression 3′ of the main body 3. The elastic fitting piece 30t is moved into the horizontal mounting hole 3h by the counter locking part 5, which enters into the fitting depression 3,' and is restored to an original location at the time point at which the assembly of the counter locking part 5 is completed, and is thus located on the upper surface of the counter locking part 5, thus generating the locking force.

That is, the elastic fitting piece 30t includes a fitting part 31, which is provided to be exposed on the side of the fitting depression, and actuation support columns 33, which are configured to pass through the horizontal mounting hole 3h and to come into contact with the respective tilted surfaces of the tilting guide plates 13.

The fitting part 31 is provided to have a shape of a triangular piece and to thus be easily moved backward when the counter locking part 5 enters.

The actuation support columns 33 is members that are integrally extended from the rear end of the fitting part 31 and have a predetermined length, are integrated with locking projections 33a, which are vertically bent at the respective ends thereof. The locking projections 33a come into contact with the respective tilted surfaces of the tilting guide plates 13, thus operating in conjunction with the ascending and descending operation of the button 10b. The above-described actuation support columns 33 may be configured such that the number of actuation support columns falls within a range of 1˜4, preferably, 2, as shown in the drawing of the present invention.

Meanwhile, although not shown, the elastic fitting piece 30t may be configured to have an elastic location displacement from the main body 3 by arranging a spring between the pair of actuation support columns 33.

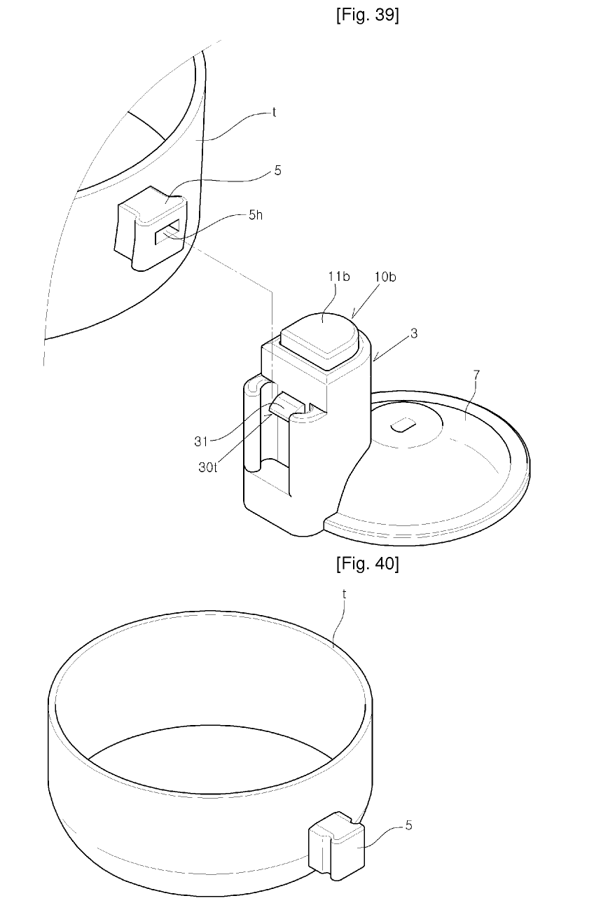

FIG. 38 is a perspective view showing an article fastening apparatus according to another embodiment of the present invention, and FIG. 39 is a sectional view illustrating the construction of the tableware fastening apparatus according to the embodiment of the present invention.

As shown in the drawing, the article fastening apparatus 1 of the present invention includes a main body 3, which is provided with a suction unit 7, and a counter locking part 5, which is configured to be selectively locked to the main body 3 and is integrated with or attached to various articles t, such as tableware. The main body 3 is provided with a fitting depression 3′ so that the counter locking part 5 can be vertically fitted thereinto in a sliding manner. In this case, the fitting depression 3′ has a shape that corresponds to that of the counter locking part 5 so the counter locking part 5 can be fitted thereinto. The tableware fastening apparatus 1, which is constructed as described above, includes the counter locking part 5, which are attached to and provided in the articles t, and the main body 3. The main body 3 includes a button 10b, which is provided in the upper portion thereof so as to be able to be elastically raised and lowered, and an elastic fitting piece 30t, which is laterally moved in response to the ascending and descending operation of the button 10b.

The above-described construction is the same as that of the above-described embodiment. Here, the article fastening apparatus 1 of the present embodiment is configured such that a position determination depression 5h is formed in the counter locking part 5, and the fitting part 31 of the elastic fitting piece 30t is fitted into the position determination depression 5h. That is, the counter locking part 5 is configured such that the position determination depression 5h is formed in a portion thereof, the elastic fitting piece 30t is located in the main body 3 so as to correspond to the position determination depression 5h. In this case, the other parts remain the same as those of the above-described embodiment, and thus detailed descriptions thereof are omitted.

The operation of the article fastening apparatus of the present invention, which is constructed as described above, is described based on the above-described embodiment below.

When the counter locking part 5, which is provided in the respective side portions of various articles t, including a food tray or tableware, is fitted into the fitting depression 3′ of the main body 3, the counter locking part 5, which is located on the entrance path of the fitting part 31 of the elastic fitting piece 30t, is moved backward by coming into contact with the counter locking part 5. Subsequently, when the counter locking part 5 is completely assembled with the fitting depression 3′ of the main body 3, the elastic fitting piece 30t is restored to the original location thereof due to the elimination of the contact with the counter locking part 5 and, as a result, protrudes from the upper portion of the counter locking part 5. Accordingly, any movement in the assembly direction is prevented by the elastic fitting piece 30t in the state in which the counter locking part 5 is fitted into the fitting depression 3′ of the main body 3.

Meanwhile, when the button 10b, which is provided in the upper portion of the main body 3 is pressed in order to separate the counter locking part 5 in the state in which the counter locking part 5 and the main body 3 are assembled with each other, the elastic fitting piece 30t, the actuation support columns 33 of which come into contact with the tilted surfaces of the tilting guide plates 13 of the button 10b, is moved backward, and thus the constraint force in the assembly direction of the counter locking part 5 is eliminated. Accordingly, the counter locking part 5 is moved in the direction opposite to the assembly direction to the fitting depression 3′ of the main body 3, and is thus separated.

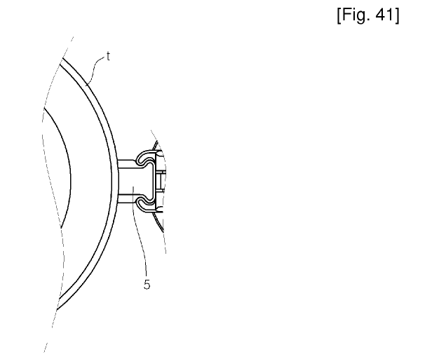

FIGS. 40 and 41 are views showing a modification of a protrusion. As shown in the drawings, a counter locking part 5 having a different shape is provided.

This invention has been described based on the preferred embodiments, described above, and the embodiments are illustrative but not restrictive. Those skilled in the art will appreciate that the embodiments can be modified, changed and adjusted in various ways without departing from the scope and spirit of the invention. Accordingly, the scope of the invention should be understood as including all of the modifications, changes and adjustments, described above, as wells the accompanying claims.

1. An apparatus for fastening tableware, the tableware being used to have a meal, comprising:
a piece of tableware (105), which is provided with a space in which food is contained;
a suction unit (100), which is closely attached to a desk or table (110) using vacuum pressure;
a support column (22), which is configured to protrude upwards from the suction unit (100); and
a locking unit, which is used to couple the tableware (105) to the support column (22);
wherein, when the support column (22) and the tableware (105) are coupled with each other, a difference in vertical position between the tableware (105) and the support column (22) is adjusted so that the tableware (105) is not inclined.

2. The apparatus according to claim 1, wherein various types of well-known locking means are used for the locking unit.

3. An apparatus for fastening tableware, the tableware being used to have a meal, comprising:
a piece of tableware (105), which is configured to contain food therein, a counter locking part (10), which is configured to protrude from a side surface of the upper portion of the tableware (105) and to have a rectangular and flat shape; and
a suction unit (100), comprising a suction cup (30), which is made of rubber material and is configured such that a lower surface thereof has a circular shape and a pulling bar (41) is formed in an upward direction from a central portion thereof, and a housing (40), which is disposed over the suction cup (30) to contain the suction cup (30) and is provided with an actuation lever (44) for rotating a hinge (43), the suction dick (30) being coupled with the pulling bar (41), a support column (22), which is vertically integrated with a side portion of the housing (40), and a locking part (49), which is configured such that a locking seat (47), having a [symbol] -shape, is formed on a side surface of the support column (22) and a stopper plate 48, having elasticity, is formed on a front surface thereof;
wherein the tableware (105) is attached to a desk or table (110) in such a way that the counter locking part (10), which protrudes from the side surface of the tableware (105), is inserted into the locking seat (47) of the locking part (49) and is unlocked using the stopper plate (48), which is coupled to be controlled.

4. The apparatus according to claim 3, wherein, when a piece of tableware 105 having a circular shape is used, the counter locking part (10) of the tableware (105) and the locking part (49) of the suction unit (100) are formed to be rounded like a side surface of the tableware (105).

5. An apparatus for fastening tableware, comprising;
a counter locking part (10), which is configured to protrude from a side surface of a piece of tableware, in which food is contained, and to be provided with a protrusion (11), which is formed such that one end thereof is extended in two side direction thereof; and
a locking stand (20), having a fitting depression (21), which is configured to protrude upwards from a housing (40) of a suction unit (100), which is provided with a circular suction cup (30), which is made of rubber material, below the housing (40), to be bent to have a hook shape in a front thereof, and to fit the counter locking part (10) thereinto, a support column (22), which is formed such that an interior thereof is vacant in a side portion of the fitting depression (21), and a button switch (25), having a [symbol] -shaped section, the button switch (25) constituting the support column (22) and having a button (24), which is formed on an upper surface of the support column (22) through a gap (23);
wherein the counter locking part (10) is fitted into the locking stand (20) and, thus, the tableware (105) and the suction unit (100) are integrated with each other, and the suction unit (100) is fastened to a table (110) for use thereof.

6. The apparatus according to claim 5, wherein a stopper protrusion (12), which protrudes from a front surface of the counter locking part (10), is formed on the counter locking part (10), and stopper depressions (26), which correspond to the stopper protrusion (12), are formed in a side surface of the button switch (25).

7. The apparatus according to claim 6, wherein the stopper depressions 26, which correspond to the stopper protrusion (12), are formed, and a pitch between the stopper depressions (26) is corrected according to thickness of an auxiliary plate (70).

8. The apparatus according to claim 5, wherein an auxiliary plate (70), which includes a circular plate (71), which is formed to have a diameter greater than that of the suction unit (100), having a circular shape, and a double-sided tape (72), which is adhered to a lower surface of the circular plate (71), are coupled to a lower surface of the suction unit (100), thus enabling use for a table (110), for which a suction method cannot be used.

9. The apparatus according to claim 5, wherein an elastic spring (80) for supporting the button switch (25) is mounted in the support column (22) of the locking stand (20).

10. The apparatus according to claim 5, wherein the locking stand (20) is configured such that one to four locking stands (20) are formed on the housing (40) of the suction unit (100).

11. The apparatus according to claim 5, wherein a separate magnet (96) is applied to the button (24) of the support column (22), thus enabling detachable attachment of a character doll (97) thereto.

12. The apparatus according to claim 5, wherein a locking part (AB) is formed on a side surface of the button switch (25).

13. An apparatus for fastening tableware, comprising:
a counter locking part (110), which is configured to protrude from a side surface of a piece of tableware (205), in which food is contained, and to be provided with a protrusion 111, which is formed such that one end thereof is extended on both sides thereof;
a support column (120), which is configured to protrude upwards from a housing (140) of a suction unit (200), which is provided with a circular suction cup 130, which is made of rubber material, below the housing 140; and
a locking part (122) having a fitting depression (121), which is configured such that a left and right ends thereof is bent to have a hook shape in one direction of a support column (120), and such that an upper end thereof is closed and a lower end thereof is open to enable the counter locking part (110) to be fitted thereinto;
wherein the tableware (205) and the suction unit (200) are integrated with each other by fitting the counter locking part (110) into the locking part (122), and the suction unit (200) is fastened to a table for use thereof.

14. The apparatus according to claim 13, wherein the locking part (122) is manufactured to be integrated with the support column (120), or is formed to be able to rotate around a hinge (125).

15. The apparatus according to claim 13 or 14, wherein a pushing plate (135), which is fastened to a downward-biasing elastic spring (134), is formed in the fitting depression (121), which is formed in the locking part (122).

16. An apparatus for fastening articles, comprising:
a counter locking part, which is provided to protrude from an article and is configured such that one end thereof is extended as both side portions thereof are concaved; and
a main body, which is provided with a fitting depression, having a shape that corresponds to that of the counter locking part so that the counter locking part is fitted thereinto in a sliding manner, and is provided with a suction unit on one side of the fitting depression;
wherein the main body comprises:
a button, which is a member that is mounted in an upper portion thereof to be able to be elastically raised and lowered, and which is provided with tilting guide plates that are formed in a lower end of the button to have respective tilted surfaces, widths of which is gradually decreased downwards; and
an elastic fitting piece, which is a part that is laterally moved by operating in conjunction with ascending and descending operation of the button, and which is configured such that one end thereof comes into contact with the tilted surfaces of the tilting guide plates and a remaining end thereof protrudes to an upper surface of the counter locking part, which is fitted into the fitting depression, thus preventing the counter locking part from being separated.

17. The apparatus according to claim 16, wherein:
the button is configured such that a pushing part, which is pressed through manipulation, guide tilted plates, which are extended from a lower end of the pushing part, and lifting guide plate, which protrude parallel to the tilting guide plates at respective sides of the tilting guide plates and is provided with respective locking projections, are integrally formed, and
the main body is provided with a seating depression, which is formed in an upper portion of the main body and is configured such that the lower end of the button is inserted thereinto, and a vertical elasticity body, which is provided on a bottom of the seating depression and generates elastic support force so that the button is raised.

18. The apparatus according to claim 16 or 17, wherein the button is provided with two or more tilting guide plates and two or more lifting guide plate.

19. The apparatus according to claim 16, wherein:
the main body is configured such that a horizontal mounting hole, in which the elastic fitting piece is laterally mounted, is formed to pass through a side surface the main body on one side in which the fitting depression is formed, and
the elastic fitting piece is provided with a fitting part, which has a shape of a triangular piece, the fitting part being moved into the horizontal mounting hole by the counter locking part, which enters into the fitting depression in a state in which one end thereof is inserted into the horizontal mounting hole, and being restored to an original location thereof at a time point at which assembly of the counter locking part is completed, and being thus located on an upper surface of the counter locking part 5, thus generating the locking force, and actuation support columns, which are parts that are extended from a rear end of the fitting part and which are configured such that ends thereof are vertically bent and come into contact with the tilted surfaces of the tilting guide plates while being slid.

20. The apparatus according to claim 16 or 19, wherein the actuation support columns is configured such that a number thereof is one to four.

21. The apparatus according to claim 16 or 19, wherein the elastic fitting piece comprises a pair of actuation support columns, which are spaced apart from each other by a gap, and a horizontal elastic body for generating elastic support force is mounted between the pair of actuation support columns.

22. An apparatus for fastening articles, comprising:
a counter locking part, which is provided to protrude from an article and is configured such that one end thereof is extended as both side portions thereof are concaved; and
a main body, which is provided with a fitting depression, having a shape that corresponds to that of the counter locking part so that the counter locking part is fitted thereinto in a sliding manner, and is provided with a suction unit on one side of the fitting depression;
wherein the main body comprises:
a button, which is a member that is mounted in an upper portion thereof to be able to be elastically raised and lowered, and which is provided with tilting guide plates that are formed in a lower end of the button to have respective tilted surfaces, widths of which is gradually decreased downwards; and
an elastic fitting piece, which is a part that is laterally moved by operating in conjunction with ascending and descending operation of the button, and which constitutes a fitting part, the fitting part being configured such that one end thereof comes into contact with the tilted surfaces of the tilting guide plates and a remaining end thereof is elastically inserted into a position determination depression, which is formed in a portion of the counter locking part, which is fitted into the fitting depression, thus generating locking force.

23. The apparatus according to claim 22, wherein:
the button is configured such that a pushing part, which is pressed through manipulation, guide tilted plates, which are extended from a lower end of the pushing part, and lifting guide plate, which protrude parallel to the tilting guide plates at respective sides of the tilting guide plates and is provided with respective locking projections, are integrally formed, and
the main body is provided with a seating depression, which is formed in an upper portion of the main body and is configured such that the lower end of the button is inserted thereinto, and a vertical elasticity body, which is provided on a bottom of the seating depression and generates elastic support force so that the button is raised.

24. The apparatus according to claim 22 or 23, wherein the button is provided with two or more tilting guide plates and two or more lifting guide plate.

25. The apparatus according to claim 22, wherein:
the main body is configured such that a horizontal mounting hole, in which the elastic fitting piece is laterally mounted, is formed to pass through a side surface the main body on one side in which the fitting depression is formed, and
the elastic fitting piece is provided with a fitting part, which has a shape of a triangular piece, the fitting part being moved into the horizontal mounting hole by the counter locking part, which enters into the fitting depression in a state in which one end thereof is inserted into the horizontal mounting hole, and being restored to an original location thereof at a time point at which assembly of the counter locking part is completed, and being thus located on an upper surface of the counter locking part 5, thus generating the locking force, and actuation support columns, which are parts that are extended from a rear end of the fitting part and which are configured such that ends thereof are vertically bent and come into contact with the tilted surfaces of the tilting guide plates while being slid.

26. The apparatus according to claim 22 or 25, wherein the actuation support columns is configured such that a number thereof is one to four.

27. The apparatus according to claim 22 or 25, wherein the elastic fitting piece comprises a pair of actuation support columns, which are spaced apart from each other by a gap, and a horizontal elastic body for generating elastic support force is mounted between the pair of actuation support columns.
